(19) United States
(12) Patent Application Publication
(10) Pub. No.: US 2005/0235552 A1
(43) Pub. Date: Oct. 27, 2005

(54) Display, transport, and storage device for fishing equipment

(75) Inventors: Stephen Gibson, Columbia, SC (US); Fred Chen, Columbia, SC (US)

Correspondence Address: DORITY & MANNING, P.A., POST OFFICE BOX 1449, GREENVILLE, SC, 29602-1449, US

(73) Assignee: Normark Innovations, Inc.

(21) Appl. No.: 10/829,672

(22) Filed: Apr. 22, 2004

(51) Int. Cl. A01K 97/06; A01K 97/10

(52) U.S. Cl. 43/54.1

(57) ABSTRACT

A display and storage rack for fishing equipment is provided. Apart from displaying and storing fishing equipment, the rack may also be used for transporting fishing equipment. The rack includes an elongated frame that carries a plate. The plate is configured for retaining fishing equipment thereon. The plate may be adjustable so that the plate may be located at a desired position along the length of the frame.

### TECHNICAL FIELD OF THE INVENTION

The present invention relates generally to a device for the display, transport, and storage of fishing equipment. More specifically, the device may be used to enhance the retail display of fishing equipment and thereby promote sales. After purchase, the present invention also provides anglers with a convenient device by which to store fishing equipment until use and also provides a convenient device for transporting such equipment while fishing or traveling to or from a fishing location.

### BACKGROUND

Fishing as a sport is enjoyed around the world. From fresh water to salt water, a wide variety of fish species exist. A myriad of fishing equipment is available such as lures, rods, reels, sinkers and bobbers each with individual particular features for enabling an angler to realize the dream of catching a true monster of the deep or simply enjoying the pleasures of the sport. Anglers generally recognize that fishing equipment must be protected from damage in order to function properly over its expected lifespan. A variety of equipment has been provided to help anglers protect, store, and transport fishing equipment.

Fishing equipment is often sold packaged inside of a plastic blister attached to a some type of backing material. Alternatively, fishing equipment is frequently sold in a carton that totally or partially conceals the product from inspection at the point of sale. Generally speaking, after purchase, the packaging materials are thrown away because such has no other purpose related to fishing. A device that could serve to both display the product for retail sale and then provide additional utility to the angler after purchase is needed.

Fishing rods, a particularly important part of anglers' equipment, can be easily damaged during shipping and thereafter by consumers while on retail display. Similarly, rods can be damaged after sale by not being adequately protected during storage or transport. The possibility of damage or loss is exacerbated by the fact than anglers are frequently trying to transport a rod and reel as well as fishing lures and other equipment to and from the fishing location.

The present invention provides for an improved device useful in both displaying and storing fishing equipment, and in transport fishing equipment to and from a desired fishing spot.

### SUMMARY

Various features and advantages of the invention will be set forth in part in the following description, or may be obvious from the description. The present invention provides a display and storage rack for both displaying and storing fishing equipment. In general, the rack includes an elongated frame and a plate that is carried by the frame. The plate is configured for retaining fishing equipment thereon. The frame and the plate may be configured so that the plate is adjustable to a desired position along the length of the frame.

One such configuration of an adjustable rack includes an elongated frame with a base and handle located on opposite ends. A pair of elongated linear rails are located between the base and the handle, and are connected on either end to the base and the handle. The plate is in sliding engagement with the rails, and is configured to be moved along the length of the rail and retained at a selected position. The plate may be retained, for instance, by a frictional engagement that may be subsequently overcome by a user in order to reposition the plate on the rails.

Any number of plates may be employed in the rack of the present invention, for instance three plates may be carried by the frame. The plates may also define a plurality of apertures that may be used with a tie for retaining fishing equipment onto the plate. In such instances, the tie is disposed through one or more of the apertures and fixed onto either itself or onto the plate in order to effect retention. Alternatively or additionally, a basket may be carried by the plate and may be configured for holding fishing equipment so that the fishing equipment is in turn retained on the plate.

The present invention also provides for a rack as described above where the plate is configured with a pair of T-shaped engagement members located on opposite ends of the plate. Each of the T-shaped engagement members has at least one retaining member located thereon. The rails of the frame each define a cavity and a slot. The T-shaped retaining members are located in the cavities and the slots and allow the plate to be slideably positioned along the length of the rails. The retaining members frictionally engage the rails in order to hold the plate once the desired position is selected.

The present invention also provides for a rack as described above that can be stood independently in an upright position. In this instance, a support leg may be rotatably attached to the frame, preferably on a base of the frame, and can be used for stabilizing the frame. Additionally or alternatively, the frame may define a mounting aperture that may be used for mounting the frame onto a surface such as a wall.

The present invention also provides a rack as set forth above that includes a rod clip attached to the handle and a fishing rod retained on the frame. The fishing rod is disposed in a compartment that is defined by the base, and is also disposed in the rod clip. A tie engages both the fishing rod and one of the rails. The fishing rod is retained on the frame by the combination of the rod clip, compartment and tie.

Also provided for in accordance with the present invention is a rack for displaying and storing fishing equipment that includes an elongated frame with a base located on one end and a handle located on an opposite end. A pair of elongated linear rails are connected on either end to the base and the handle. Three plates that define a plurality of apertures are present and are in sliding engagement with the rails. The plates are configured for retaining fishing equipment and for being moved along the length of the rails. At least one of the plates carries a basket that is configured for holding fishing equipment so that the fishing equipment is retained on the plate. Each of the plates has at least one retaining member that frictionally retains the plate at a selected position on the rails.

These and other features, aspects and advantages of the present invention will become better understood with reference to the following description and appended claims. The accompanying drawings, which are incorporated in and constitute a part of this specification, illustrate embodiments of the invention, and, together with the description, serve to explain the principles of the invention.

### BRIEF DESCRIPTION OF THE DRAWINGS

FIG. 1 is a perspective view of a display and storage rack in accordance with the present invention.

FIG. 2 is a perspective view of the display and storage rack of FIG. 1 that includes a fishing rod, reel, and tackle box retained thereon.

FIG. 3 is a perspective view that shows a plate in sliding engagement with a pair of rails in accordance with one exemplary embodiment of the present invention.

FIG. 4 is an exploded assembly view of a plate and a basket used in accordance with one exemplary embodiment of the present invention.

FIG. 5 is a perspective view of a handle used in accordance with one exemplary embodiment of the present invention.

FIG. 6 is an exploded assembly view of a base and a support leg used in accordance with one exemplary embodiment of the present invention.

### DETAILED DESCRIPTION OF PREFERRED EMBODIMENTS

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

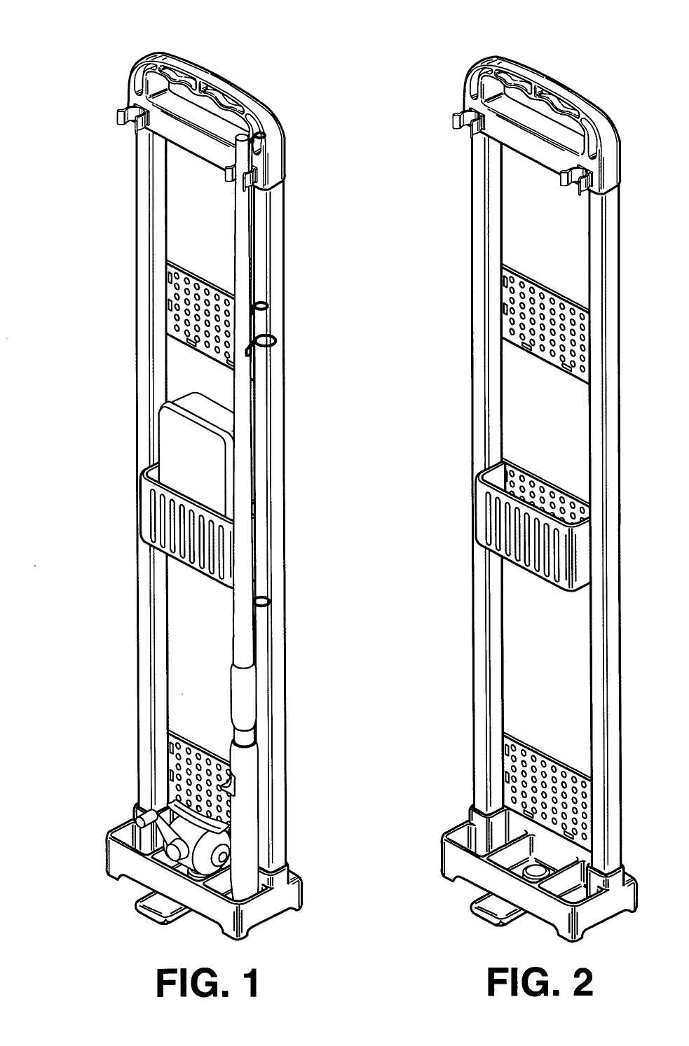

In one exemplary embodiment, the present invention provides for a display and storage rack 10, as shown for example in FIG. 1, that is used for displaying fishing equipment in a store. Upon purchasing the fishing equipment, the rack 10 may be used by the fisherman to transport the purchased fishing equipment from the store. The rack 10 may then be used by the fisherman as a device for storing fishing equipment including other equipment used by the fisherman that may not have been purchased with rack 10. If desired, the fisherman may also use the rack 10 as a transporting device in order to help contain and protect the fishing equipment during travel between various locations. The rack 10 may be adjustable in order to accommodate different types, amounts and sizes of fishing equipment. As used herein, fishing equipment refers to lures, bait, rods, reels, tools, and other equipment and gear used in connection with fishing.

Rack 10 includes an elongated frame 12 that has a base 20 located on one end. Although shown standing in an upright position, rack 10 may also be displayed or stored in a horizontal position if so desired. A pair of rails 16, 18 extend from base 20 and are connected on an opposite end to a handle 22 that aids in transport of frame 12. A plate 14 spans the distance between the rails 16, 18 and is configured for retaining fishing equipment thereon. Although shown as employing three plates 14, any number of plates 14 may be used in accordance with the present invention. Plate 14 may be fixed at a single location with respect to rails 16, 18 or may be configured to be adjustable so that different positions on rails 16, 18 may be selected. An adjustable plate 14 may be advantageous in reconfiguring rack 10 in order to hold extra fishing equipment owned by the fisherman. An adjustable plate 14 may also be advantageous in that the rack 10 may be adjusted by the manufacturer or store owner in order to better fit or display different types of fishing equipment thereon.

An example of how certain types of fishing equipment may be retained on rack 10 is shown in FIG. 2. Here, a fishing rod 32 rests inside of a compartment 50 defined in base 20. Rod 32 is held onto rail 18 by a tie 34, that may be a self-locking plastic strip as is commonly known in the art. Rod 32 may be further secured at one end by a rod clip 26 attached to handle 22. Although not shown, an additional rod may be retained on rack 10 by attachment to rail 16, rod clip 24 and placement in compartment 54 in a manner similar to that shown with respect to rod 32.

The center plate 14 has a basket 30 attached thereto. A tackle box 28 that may contain lures, hooks, sinkers, bobbers and the like is placed in basket 30 and retained onto plate 14. Tackle box 28 may be sized so as to be force fit between basket 30 and plate 14 for a secure retention, or could alternatively be loosely placed between these two components.

Other fishing equipment retained on rack 10 includes a reel 36 that is positioned in a compartment 52 defined by base 20. Reel 36 may be retained onto plate 14 by a tie (not shown) similar to tie 34. Plate 14 defines a plurality of apertures 38 that include a series of holes 40 through which the tie may be disposed in order to retain reel 36 onto plate 14. Reel 36 may therefore be retained onto rack 10 through a combination of attachment to plate 14 and or placement in compartment 52.

Additional fishing equipment may also be retained on rack 10. For instance, a box or blister package of lures, hooks, sinkers, bobbers or the like may be retained on one or more of the plates 14 through the use of adhesion or mechanical fasteners such as ties disposed through one or more holes 40 in plate 14. Plate 14 can have a flat surface that contacts the fishing equipment when retained thereon, no other structure being present between the fishing equipment and the flat surface of plate 14. It is to be understood that any type of retention between the fishing equipment and plate 14 or other portions of rack 10 may be employed in accordance with various exemplary embodiments of the present invention as is known to one of ordinary skill in the art. The ties and basket 30 are only examples of how retention of the fishing equipment can be accomplished.

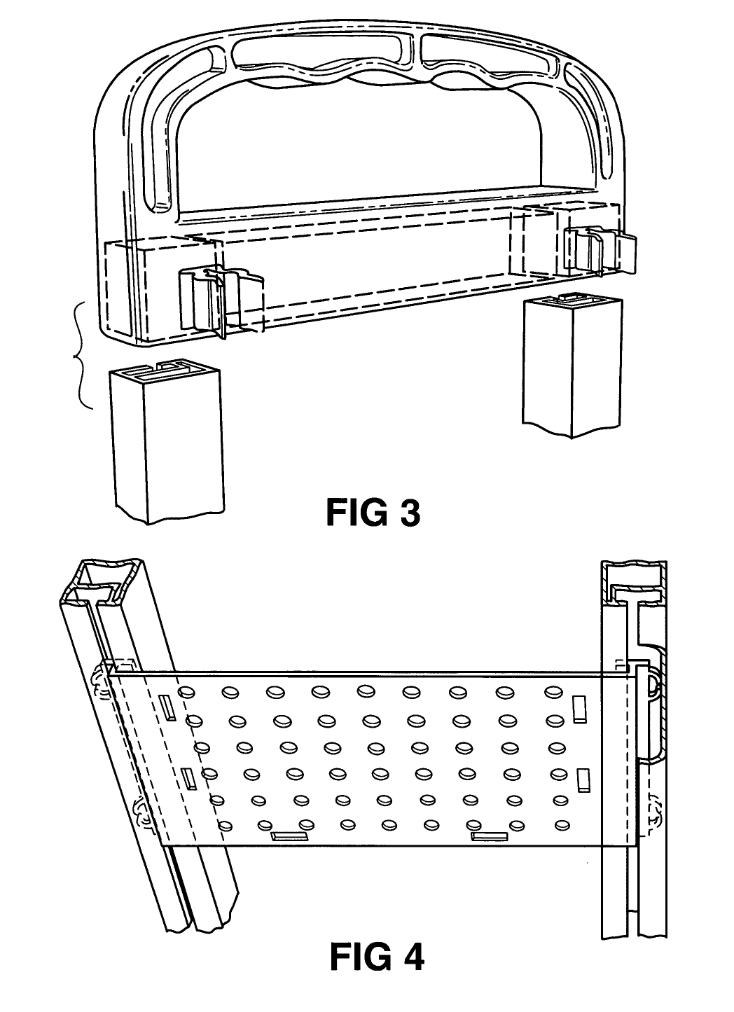

FIG. 3 shows an exemplary embodiment of the sliding engagement between plate 14 and rails 16, 18. Plate 14 is provided with T-shaped engagement members 60 on either end that are received in a first cavity 62 and slot 66 defined in each of the rails 16, 18. In such a configuration, plate 14 may be slid along rails 16, 18 to a desired location. Retaining members 56 are located on the T-shaped engagement members 60. Retaining members 56 are urged against an inner surface of rails 16, 18 and act to prevent plate 14 from moving along rails 16, 18 through a frictional engagement. Retaining members 56 are configured for frictional engagement by being sized large enough so that the retaining members 56 are deformed upon insertion into the first cavity 62. This deformation in turn causes a frictional engagement between retaining members 56 and the inner surface of rails 16, 18. A fisherman may apply force to plate 14 sufficient to overcome the frictional engagement between retaining members 56 and rails 16, 18 so that plate 14 is moved to a new position along rails 16, 18. Rails 16, 18 define a second cavity 64 that is present in order to reduce the overall weight of frame 12 while still providing for sufficient structural rigidity of rails 16, 18. Rails 16, 18 could alternatively be designed with a single cavity into which the T-shaped engagement members 60 are disposed.

Aside from adjusting the position of plate 14 on rails 16, 18, other components of rack 10 may be adjusted in order to adapt frame 10 for a desired purpose. For instance, FIG. 4 shows a configuration where basket 30 may be releasably attached to plate 14. The plurality of apertures 38 define both a series of holes 40 and slots 42. Basket 30 has a plurality of tabs 58 that engage corresponding slots 42 in plate 14. After attachment, basket 30 may then be removed from plate 14 and attached to a different plate 14 on rack 10, or alternatively basket 30 may be completely removed from rack 10 if so desired.

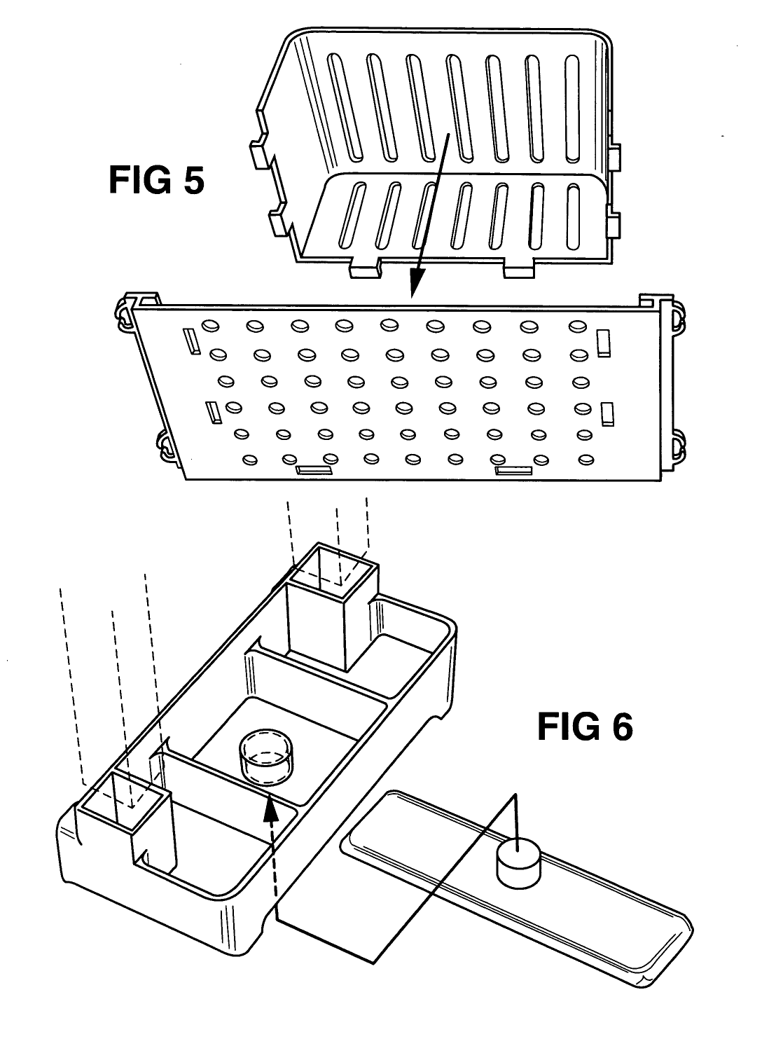

Other adjustments of rack 10 are also possible as shown for instance in FIG. 5 where handle 22 is configured to be removably attached to rails 16, 18. In such an instance, handle 22 may be pulled off of rails 16, 18 and one or more plates 14 can be slid up through the first cavity 64 in rails 16, 18 and subsequently removed from rack 10. Additionally, should extra plates 14 be desired for a particular application, these additional plates 14 may be inserted into the first cavities 62 after removal of handle 22. Handle 22 may then be reattached to rails 16, 18. Removable attachment between handle 22 and rails 16, 18 can be attained in any manner commonly known to one skilled in the art. For instance, these components may be frictionally fit onto one another, or releasably attached through mechanical fasteners such as clips, hook and loop type fasteners, bolts, screws or the like. Additionally, handle 22 can be permanently attached to rails 16, 18 in accordance with other exemplary embodiments of the present invention.

Rack 10 can be displayed or stored in either a vertical, horizontal, or inclined orientation. Rack 10 can be mounted onto a surface or can be configured in order to stand independent of another structure. One or more mounting apertures 68 (FIG. 5) can be defined in handle 22 in order to allow rack 10 to be mounted, for instance, onto one or more hooks or bolts protruding from a wall. Alternatively, as can be seen in FIGS. 1, 2 and 6, rack 10 can be configured to stand independently of other structures by simply standing on base 20. In this regard, base 20 may be provided with a support leg 44 that can be used to help provide additional stability to rack 10 when standing independently.

As shown in FIG. 6, support leg 44 includes a projection 46 that is adapted to be rotatably received within a receiving cavity 48 defined in base 20. Support leg 44 can be positioned beyond base 20 when additional stability is desired, and can be rotated so as to be positioned completely underneath base 20 for situations such as when rack 10 is mounted onto a wall, or during transport of rack 10. Projection 46 can be placed into rotatable engagement with receiving cavity 48 in any manner commonly known to one skilled in the art. For instance, these components may be in frictional engagement with one another, or a bearing can be employed in order to allow rotation. Further, support leg 44 need not be in rotatable engagement with base 20 in other exemplary embodiments. Support leg 44 may simply be rigidly attached to base 20, or may be removable from base 20 so the fisherman can remove support leg 44 when desired.

It should be understood that the present invention includes various modifications that can be made to the exemplary embodiments of rack 10 as described herein that come within the scope of the appended claims and their equivalents.

1. A display and storage rack for displaying and storing fishing equipment, comprising:
an elongated frame having a pair of substantially parallel rails oppositely disposed to one another, each of the rails located on a side of the frame, the frame having a base located on one end, the base contiguous with the rails, the base configured for contact with a surface and configured for providing at least partial support to the frame when the frame is stood in an upright position; and
a plate configured for retaining fishing equipment thereon, the plate is carried by the pair of rails.

2. The display and storage rack as set forth in claim 1, wherein the frame includes a handle located on an opposite end of the frame from the base, and wherein the rails are located between both the base and the handle, and wherein the plate is carried by the pair of rails.

3. The display and storage rack as set forth in claim 2, wherein the plate has a pair of T-shaped engagement members located on opposite ends thereof and each of the T-shaped engagement members has at least one retaining member located thereon, and wherein each of the rails defines a slot, and wherein the T-shaped retaining members are located in the slots and are slideably positioned along the slots, and wherein the retaining members frictionally engage the rails in order to hold the plate at a selected position.

4. The display and storage rack as set forth in claim 1, further comprising a support leg rotatably attached to the frame for use in stabilizing the frame when the frame is stood independently in an upright position.

5. The display and storage rack as set forth in claim 1, wherein the plate defines a plurality of apertures.

6. The display and storage rack as set forth in claim 5, wherein the apertures are holes and slots.

7. The display and storage rack as set forth in claim 1, wherein the frame defines at least one mounting aperture for use in mounting the frame onto a surface.

8. The display and storage rack as set forth in claim 1, wherein the plate is configured for being selectively positioned along the length of the frame.

9. The display and storage rack as set forth in claim 8, wherein the plate has at least one retaining member located thereon that frictionally retains the plate at a selected position on the frame.

10. A display and storage rack for displaying and storing fishing equipment, comprising:
an elongated frame having a base located on one end of the frame and a handle located on an opposite end of the frame, the frame having a pair of elongated linear rails located between the base and the handle and wherein each rail is connected on either end of the rail to the base and the handle; and
at least one plate in sliding engagement with the pair of rails, the plate is configured to be moved along the length of the linear rails and be retained at a selected position on the rails, the plate is configured for retaining fishing equipment thereon.

11. The display and storage rack as set forth in claim 10, wherein three plates are present, and wherein at least one of the plates carries a basket.

12. The display and storage rack as set forth in claim 10, further comprising:
a rod clip attached to the handle; and
a fishing rod retained on the frame, the fishing rod is disposed in a compartment defined by the base and is also disposed in the rod clip;
wherein the fishing rod is retained on the frame by the rod clip and compartment.

13. The display and storage rack as set forth in claim 10, wherein the plate has a pair of T-shaped engagement members located on opposite ends thereof and each of the T-shaped engagement members has at least one retaining member located thereon, and wherein each of the rails defines a slot, and wherein the T-shaped retaining members are located in the slots to effect sliding engagement between the plate and the pair of rails, and wherein the retaining members frictionally engage the rails in order to hold the plate at a selected position.

14. The display and storage rack as set forth in claim 10, further comprising a support leg rotatably attached to the base for use in stabilizing the frame when the frame is stood independently in an upright position.

15. The display and storage rack as set forth in claim 10, wherein the plate defines a plurality of holes and slots.

16. The display and storage rack as set forth in claim 10, wherein the handle defines a mounting aperture for use in mounting the frame onto a surface.

17. The display and storage rack as set forth in claim 10, wherein the plate has at least one retaining member located thereon that frictionally retains the plate at a selected position on the rails.

18. A display and storage rack for displaying and storing fishing equipment, comprising:
an elongated frame having a base located on one end of the frame and a handle located on an opposite end of the frame, the frame having a pair of elongated linear rails located between the base and the handle and wherein each rail is connected on either end of the rail to the base and the handle; and
three plates in sliding engagement with the pair of rails, each of the plates define a plurality of apertures, the plates are configured to be moved along the length of the linear rails, the plates are configured for retaining fishing equipment thereon, each plate has at least one retaining member located thereon that frictionally retains the plate at a selected position on the rails.
